(19) United States
(12) Patent Application Publication
(10) Pub. No.: US 2017/0019014 A1
(43) Pub. Date: Jan. 19, 2017

(54) MIDPOINT CONTROL AND GAIN SCHEDULING FOR POWER CONVERTERS

(71) Applicant: FINsix Corporation, Menlo Park, CA (US)

(72) Inventors: Anthony Sagneri, Palo Alto, CA (US); Victor Sinow, Oakland, CA (US); Ranko Sredojevic, Berkeley, CA (US); Milovan Kovacevic, Redwood City, CA (US)

(21) Appl. No.: 15/270,241

(22) Filed: Sep. 20, 2016

Related U.S. Application Data
(63) Continuation of application No. PCT/US2016/022577, filed on Mar. 16, 2016.
(60) Provisional application No. 62/147,556, filed on Apr. 14, 2015.
(60) Provisional application No. 62/133,567, filed on Mar. 16, 2015.

(51) Int. Cl. H02M 1/00

(52) U.S. Cl. CPC H02M 1/00; H02M 2001/0003

(57) ABSTRACT

A method and controller for controlling a power converter having a plurality of stacked power cells. A method includes controlling the plurality of stacked power cells using a common mode control parameter as well as a differential mode control parameter that controls a voltage of a connection terminal between respective power cells of the plurality of stacked power cells.

### CROSS-REFERENCE TO RELATED APPLICATIONS

This application is a continuation of International PCT Application PCT/US2016/022577, titled “MIDPOINT CONTROL AND GAIN SCHEDULING FOR POWER CONVERTERS,” filed Mar. 16, 2016, which claims priority to U.S. provisional application Ser. No. 62/133,567, titled “RESONANT POWER CONVERTERS AND STACKED POWER CONVERTERS AND ASSOCIATED CONTROL TECHNIQUES,” filed Mar. 16, 2015, and U.S. provisional application Ser. No. 62/147,556, titled “MIDPOINT CONTROL AND GAIN SCHEDULING FOR POWER CONVERTERS,” filed Apr. 14, 2015, each of which is incorporated herein by reference in its entirety.

### DISCUSSION OF RELATED ART

Power converters are used in a variety of applications to convert electricity from one form to another. For example, AC/DC power converters convert the AC line voltage into a DC voltage accepted by an electronic device.

### SUMMARY

Some embodiments relate to a method of controlling a power converter having a plurality of stacked power cells. The method includes controlling the plurality of stacked power cells using a common mode control parameter that controls respective power cells of the plurality of stacked power cells in a same way and a differential mode control parameter that controls respective power cells of the plurality of stacked power cells in an opposing way to change a voltage of a connection terminal between at least two of the plurality of stacked power cells.

Some embodiments relate to at least one computer readable storage medium having stored thereon instructions, which, when executed by a processor, perform a method of controlling a power converter. The method includes controlling the plurality of stacked power cells using a common mode control parameter that controls respective power cells of the plurality of stacked power cells in a same way and a differential mode control parameter that controls respective power cells of the plurality of stacked power cells in an opposing way to change a voltage of a connection terminal between at least two of the plurality of stacked power cells.

Some embodiments relate to a controller for a power converter having a plurality of stacked power cells. The controller includes circuitry configured to control the plurality of stacked power cells using a common mode control parameter that controls respective power cells of the plurality of stacked power cells in a same way and a differential mode control parameter that controls respective power cells of the plurality of stacked power cells in an opposing way to change a voltage of a connection terminal between at least two of the plurality of stacked power cells.

Some embodiments relate to a power converter including a plurality of stacked power cells and a controller. The controller is configured to control the plurality of stacked power cells using a common mode control parameter that controls respective power cells of the plurality of stacked power cells in a same way and a differential mode control parameter that controls respective power cells of the plurality of stacked power cells in an opposing way to change a voltage of a connection terminal between at least two of the plurality of stacked power cells.

Some embodiments relate to a method of controlling a power converter having a plurality of stacked power cells. The method includes controlling a voltage of a connection terminal between the plurality of stacked power cells at least in part by: modifying a first control parameter of at least one first power cell of the plurality of stacked power cells to produce a change in output of the at least one first power cell; and modifying a second control parameter of at least one second power cell of the plurality of stacked power cells to produce a change in output of the at least one second power cell that is opposite to the change in output of the at least one first power cell.

Some embodiments relate to at least one computer readable storage medium having stored thereon instructions, which, when executed by a processor, perform a method of controlling a power converter. The method includes controlling a voltage of a connection terminal between the plurality of stacked power cells at least in part by: modifying a first control parameter of at least one first power cell of the plurality of stacked power cells to produce a change in output of the at least one first power cell; and modifying a second control parameter of at least one second power cell of the plurality of stacked power cells to produce a change in output of the at least one second power cell that is opposite to the change in output of the at least one first power cell.

Some embodiments relate to a controller for a power converter having a plurality of stacked power cells. The controller includes circuitry configured to control a voltage of a connection terminal between the plurality of stacked power cells at least in part by: modifying a first control parameter of at least one first power cell of the plurality of stacked power cells to produce a change in output of the at least one first power cell; and modifying a second control parameter of at least one second power cell of the plurality of stacked power cells to produce a change in output of the at least one second power cell that is opposite to the change in output of the at least one first power cell.

Some embodiments relate to a power converter that includes a plurality of stacked power cells and a controller. The controller is configured to control a voltage of a connection terminal between the plurality of stacked power cells at least in part by: modifying a first control parameter of at least one first power cell of the plurality of stacked power cells to produce a change in output of the at least one first power cell; and modifying a second control parameter of at least one second power cell of the plurality of stacked power cells to produce a change in output of the at least one second power cell that is opposite to the change in output of the at least one first power cell.

Some embodiments relate to a method of controlling a power converter having a plurality of stacked power cells. The method includes controlling at least one first power cell of the plurality of stacked power cells to control an output of the power converter, and controlling at least one second power cell of the plurality of stacked power cells to control a voltage of a connection terminal between respective power cells of the plurality of stacked power cells.

Some embodiments relate to at least one computer readable storage medium having stored thereon instructions, which, when executed by a processor, perform a method of controlling a power converter having a plurality of stacked power cells. The method includes controlling at least one first power cell of the plurality of stacked power cells to control an output of the power converter, and controlling at least one second power cell of the plurality of stacked power cells to control a voltage of a connection terminal between respective power cells of the plurality of stacked power cells.

Some embodiments relate to a controller for a power converter having a plurality of stacked power cells. The controller includes circuitry configured to control at least one first power cell of the plurality of stacked power cells to control an output of the power converter, and to control at least one second power cell of the plurality of stacked power cells to control a voltage of a connection terminal between respective power cells of the plurality of stacked power cells.

Some embodiments relate to a method of controlling a power converter having a plurality of stacked power cells including at least one first power cell connected to at least one second power cell at a connection terminal. The method includes (A) controlling the at least one first power cell reduce a power processed by the at least one first power cell in response to a voltage of the connection terminal reaching a voltage threshold; or (B) controlling the at least one second power cell reduce a power processed by the at least one second power cell in response to the voltage of the connection terminal reaching a lower voltage threshold.

Some embodiments relate to at least one computer readable storage medium having stored thereon instructions, which, when executed by a processor, perform a method of controlling a power converter including at least one first power cell connected to at least one second power cell at a connection terminal. The method includes (A) controlling the at least one first power cell reduce a power processed by the at least one first power cell in response to a voltage of the connection terminal reaching a voltage threshold; or (B) controlling the at least one second power cell reduce a power processed by the at least one second power cell in response to the voltage of the connection terminal reaching a lower voltage threshold.

Some embodiments relate to a controller for a power converter having a plurality of stacked power cells including at least one first power cell connected to at least one second power cell at a connection terminal. The controller includes circuitry configured to: control the at least one first power cell reduce a power processed by the at least one first power cell in response to a voltage of the connection terminal reaching a voltage threshold; or control the at least one second power cell reduce a power processed by the at least one second power cell in response to the voltage of the connection terminal reaching a lower voltage threshold.

Some embodiments relate to a method of controlling a power converter. The method includes controlling the power converter using a control loop; and selecting a gain for the control loop based on an input of the power converter, an output of the power converter, or both an input and an output of the power converter.

Some embodiments relate to a least one computer readable storage medium having stored thereon instructions, which, when executed by a processor, perform a method of controlling a power converter. The method includes controlling the power converter using a control loop; and

selecting a gain for the control loop based on an input of the power converter, an output of the power converter, or both an input and an output of the power converter.

Some embodiments relate to a controller for a power converter. The controller includes

circuitry configured to control the power converter using a control loop and to select a gain for the control loop based on an input of the power converter, an output of the power converter, or both an input and an output of the power converter.

Some embodiments relate to a power converter that includes a plurality of stacked power cells and a controller. The controller is configured to control the plurality of stacked power cells using a control loop and to select a gain for the control loop based on an input of the power converter, an output of the power converter, or both an input and an output of the power converter.

The foregoing summary is provided by way of illustration and is not intended to be limiting.

### BRIEF DESCRIPTION OF DRAWINGS

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques described herein.

FIG. 1 shows a diagram of a power converter having N stacked power converter cells.

FIG. 2A shows a power cell including a buck converter.

FIG. 2B shows a switching period in which the switch S1 is turned on by a control signal for a duration of t1.

FIG. 2C shows a sub-modulation control signal that turns the power cell on and off with a period T2.

FIG. 2D illustrates circuitry for controlling the switches S1 and S2 based on the duty ratio D and the sub-modulation duty ratio M.

FIG. 3A shows a power converter having two stacked cells with their inputs connected in series by an input connection and their outputs connected in parallel by an output connection, according to some embodiments.

FIG. 3B shows a flowchart of a method of controlling a power converter having a plurality of stacked power cells, according to some embodiments.

FIG. 4 shows a voltage that oscillates between a nominal voltage and the edges of a hysteresis band.

FIG. 5 shows an example of a power converter with three stacked cells having their inputs connected in series and their outputs connected in parallel.

FIG. 6 shows an example of a power converter with four stacked cells having their inputs connected in series and their outputs connected in parallel.

FIG. 7 shows an example of a power converter with two stacked cells having their inputs connected in parallel and their outputs connected in series.

FIG. 8 shows an example with two stacked cells having their inputs connected in series and their outputs connected in series, with a midpoint MP1 on the input and a midpoint MP2 on the output.

FIG. 9 shows another control technique for controlling the output of the power converter and the midpoint voltage using different control loops, according to some embodiments.

FIG. 10 illustrates a power converter with a controller that controls a power converter using a controllable gain.

FIG. 11 illustrates a power converter with a controller that controls a plurality of stacked cells of a power converter.

FIG. 12 is a block diagram of an illustrative computing device that can implement the control techniques described herein.

### DETAILED DESCRIPTION

It has been appreciated that a power converter including a plurality of power converter cells (hereafter referred to as “cells,” or “power cells”) may have a number of advantages. The cells may be interconnected, or “stacked,” with their inputs connected in series or parallel and their outputs connected in series or parallel. Stacking power cells by connecting their inputs and/or outputs in series and/or parallel can allow handling a larger voltage and/or a larger current than would be possible with a single cell. Stacking power cells may reduce switch stresses in the power converter and/or allow for using smaller and/or less expensive switches that do not need to handle the full voltage or current. Examples of ways in which cells may be stacked in series and/or parallel are shown in U.S. Pat. No. 9,184,660, which is hereby incorporated by reference in its entirety.

The present inventors have recognized and appreciated that stacking of cells leads to additional complexity due to interactions between the cells and shifting voltages at points of connection between the cells. Described herein are control techniques that can improve the control of stacked power cells.

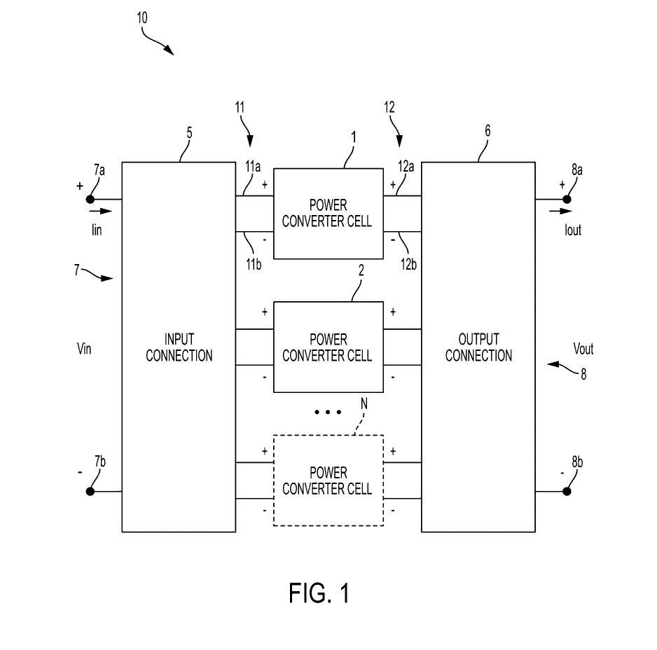

FIG. 1 shows a diagram of a power converter 10 having N stacked power cells 1, 2, . . . , N. The cells 1, 2, . . . , N are individual power converters that collectively form the power converter 10. In operation, each of the cells may process its share of the power processed by power converter 10. The cells may be the same as one another, or may be different from one another. The cells may be designed to process the same level or different levels of power, voltage and/or current.

The cells may be any type of power converter, such as an AC/DC converter, DC/AC converter, DC/DC converter, or AC/AC converter, for example. The cells may have any suitable converter topology, such as phi-2, LLC, buck, etc. Phi-2 converters according to some embodiments are described in further detail in U.S. Pat. No. 9,184,660. In some embodiments, the stacked cells may be switched at a relatively high switching frequency, such as a frequency of 500 kHz or greater, 1 MHz or greater, or 5 MHz, or greater, such as 30 MHz-300 MHz. However, the techniques described herein are not limited in this respect, as in some embodiments they may be switched at lower or higher frequencies.

Power converter 10 has an input connection 5 that interconnects the inputs 11 of the cells and the input 7 of the power converter. The inputs 11 of the cells each have a high-side terminal 11a and a low-side terminal 11b. The input 7 of the power converter 10 has a high-side terminal 7a and a low-side terminal 7b. Input connection 5 may connect the inputs 11 of the cells in series, in parallel, or in a combination of series and parallel. Power converter 10 also has an output connection 6 that interconnects the outputs 12 of the cells and the output 8 of the power converter. The outputs 12 of the cells each have a high-side terminal 12a and a low-side terminal 12b. The output 8 of the power converter 10 has a high-side terminal 8a and a low-side terminal 8b. Output connection 6 may connect the outputs 12 of the cells in series, in parallel, or in a combination of series and parallel. Series connections may involve connecting the input or output terminals such that a low-side terminal (11b or 12b) of a cell is connected to the high-side terminal (11a or 12a, respectively) of the adjacent cell. Parallel connections may involve connecting the high-side terminals (11a, 12a) together and the low-side terminals (11b, 12b) together. The selection of series and/or parallel connections for the input connection 5 and output connection 6 may be made based on any number of factors, such as the magnitude of the input and/or output voltage of the power converter 10, the magnitude of the input and/or output current, or other factors, such as the rating of components of the cells. In some embodiments, the input connection 5 and/or the output connection 6 may include switches that are controlled to change the connection between the cells (e.g., to switch cell inputs into series or parallel with one another, to switch cell outputs into series or parallel with one another and to change between series and parallel connections).

When power cells are stacked, there are one or more connection terminals, also termed “midpoints,” between respective cells. For cells connected in series, their midpoints are nominally at a certain voltage depending on the voltage across the converter input or output, the number of cells connected, and the location of the midpoint within the series stack. As an example, if power converter 10 has two cells (e.g., cells 1 and 2) that have their inputs connected in series, and the two cells are the same as one another, the voltage at the midpoint between their inputs connection terminals nominally is at a voltage of Vin/2, half the input voltage of the power converter.

The inventors have recognized and appreciated that the midpoints can drift from their desired operating points. The power cells may have differences in components, or may be controlled differently. For these reasons or others, the midpoint voltage(s) may drift from a nominal operating point. As a result, the voltage, current and/or power may not be divided between the stacked power cells as designed. Maintaining the nominal midpoint voltage may be desirable for a number of reasons, such as to keep the cells in their desired operating range(s), to keep components within their voltage and/or current limits, and/or to improve stability of the power converter. The inventors have recognized and appreciated the voltage at the midpoint(s) may be unstable, as a drift in voltage in one direction may be reinforced by positive feedback within the power converter.

Described herein are circuits and techniques for controlling stacked power cells that can manage the voltage(s) at the connection terminal(s) between the cells. In some embodiments the voltage of the midpoint(s) may be regulated to stay at a desired value or to stay within a desired range. In some embodiments, the voltage of the midpoint(s) is managed by control of the power cell(s) using one or more control parameters.

Controlling the power cells in a way that nominally maintains the voltage of the midpoint(s) can be performed by using a “common mode” control parameter. The common mode control parameter may control the cells in the same way, which nominally maintains the midpoint voltage(s) constant. The common mode control parameter may change the effective impedance of the power cells in the same way, to increase or decrease the output and/or input (voltage, current and/or power) of the power converter as a whole, while nominally leaving the midpoint voltage(s) unchanged.

In some embodiments, the voltage of the midpoint(s) can be changed in a desired way. Controlling the stacked power cells in a way that changes the voltage of the connection terminal(s) in a selected direction can be performed using a “differential mode” control parameter. In some embodiments, the voltage at the midpoint(s) may be measured by suitable measurement and/or control circuitry, and if the voltage drifts from a nominal value, the cells can be controlled using the differential mode control parameter to modify the midpoint voltage(s) such that it returns to its nominal value. Alternatively, the voltage at the midpoint(s) may be controlled to change to another desired value. The differential mode control parameter may control different cells in an opposing way that changes the voltage at the midpoint without affecting the input or output of the power converter. For example, the differential mode control parameter may control one power cell on one side of the midpoint to increase its output power and control another power cell on the other side of the midpoint to decrease its output power by the same amount. The difference in current through the two converters pulls the midpoint voltage in a selected direction. By controlling the cells on either side of the midpoint to produce equal and opposite changes in output power, the total output power of the power converter remains the same.

In some embodiments, the stacked power cells may be controlled using both a common mode control parameter and a differential mode control parameter. For example, if the output power of the power converter as a whole is desired to be increased, and the voltage at a connection terminal is desired to be changed, the common mode control parameter may control the power cells to increase the output power of the power converter, and the differential mode control parameter may control the power cells to change the voltage at one or more connection terminals between the power cells. In some embodiments, the control parameter for driving each cell may be the sum (or difference) of the common mode control parameter and a differential mode control parameter, as described below.

Prior to discussing such circuits and control techniques in further detail, control of a single power cell will be discussed to illustrate the control of a power converter based on control parameters such as duty ratio, sub-modulation duty ratio and switching frequency.

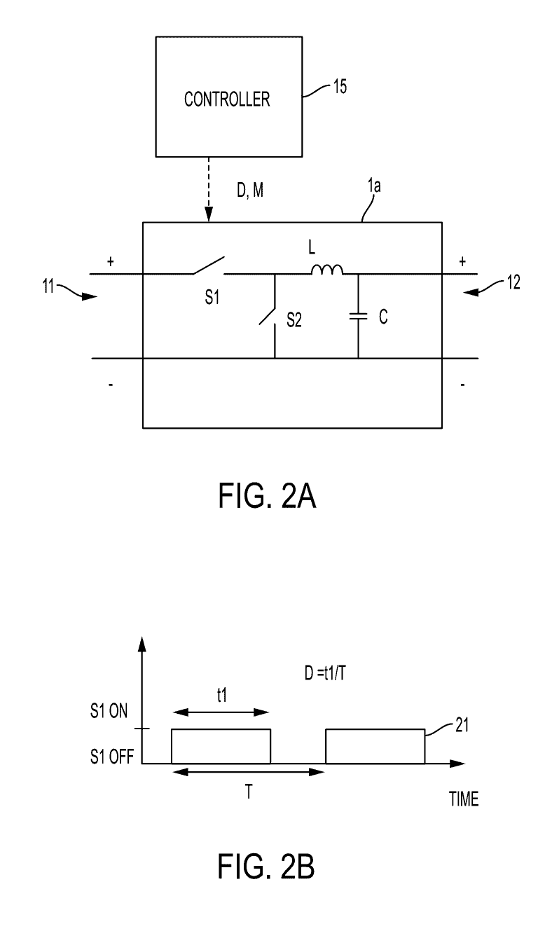

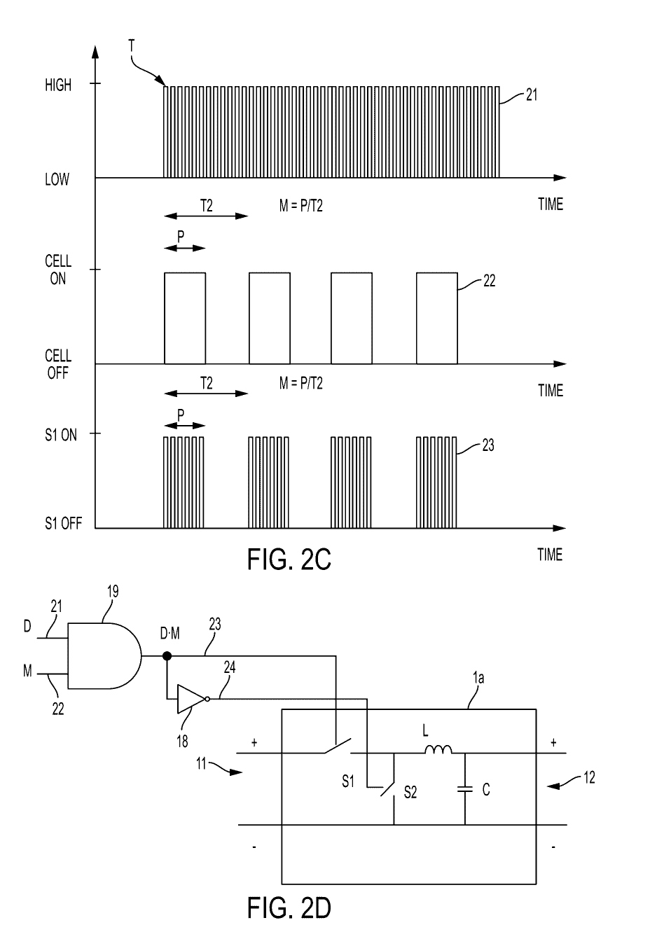

FIG. 2A shows a power cell 1a including a buck converter, by way of example. The buck converter includes a high-side switch S1 and a low-side switch S2. The buck converter switches between turning switch S1 on (with switch S2 off) and turning switch S2 on (with switch S1 off). The fraction of a switching period for which S1 is turned on is duty ratio (D) of the power cell 1a. The switching of the switches S1 and S2 at a duty ratio D is controlled by a controller 15. Controller 15 may use any suitable control technique to control the power cell 1a, such as feedback or feedforward control, for example. Pulse width modulation (PWM) is one suitable control technique, though PWM is only one example of a technique for controlling a power converter based on duty ratio. Regardless of the technique used for controlling the power cell 1, in continuous conduction mode the output voltage (across the output 12) of the power cell 1a is proportional to the time average of the duty ratio D, which is controlled by controller 15. Switches S1 and S2 produce a square wave voltage that is filtered by the passive elements including inductor L and capacitor C to produce an output voltage proportional to the time average of the duty ratio D. FIG. 2B shows a switching period T in which the switch S1 is turned on by switching control signal 21 for a duration of t1. The duty ratio D is the fraction of the switching period for which S1 is turned on, and is equal to t1/T.

Another way of controlling a power converter based on duty ratio is illustrated in FIG. 2C. In the technique of FIG. 2C, the entire power cell 1a is turned on and off, or “sub-modulated” at a frequency lower than the switching frequency of the power cell 1a. FIG. 2C shows switching control signal 21 on a longer timescale than FIG. 2B. FIG. 2C also shows a sub-modulation control signal 22 that turns the power cell 1a on and off with a sub-modulation period T2. The power cell 1a is turned on for a period P during the period T2. The fraction of time for which the power cell 1a is turned on termed the “sub-modulation duty ratio,” denoted M, which is equal to P/T2. The output of the power converter 1a can be controlled by controlling the sub-modulation duty ratio M. Increasing the sub-modulation duty ratio M increases the output voltage of the buck converter. Conversely, decreasing the sub-modulation duty ratio M decreases the output voltage of the buck converter. In some embodiments, the duty ratio D of the power cell may be held constant while the sub-modulation duty ratio is changed. In some embodiments, control of both the duty ratio D and the sub-modulation duty ratio M may be performed. In some embodiments, both the duty ratio D and the sub-modulation duty ratio M may be controlled to vary, which can provide two degrees of freedom for control of the power cell 1a.

FIG. 2D illustrates circuitry for controlling the switches S1 and S2 based on the duty ratio D and the sub-modulation duty ratio M. The AND gate 19 receives switching signal 21 having a duty ratio D and sub-modulation control signal 22 having a duty ratio M. The AND gate 19 multiplies these signals to produce an output 23 equal to D·M that is high when both D and M are high, and low otherwise. Signal 23 is provided to the control terminal of switch S1 to control switch S1. Switch S2 may be controlled by signal 24 that is complementary to signal 23. An inverter 18 can produce signal 24 based on signal 23. Suitable delay(s) can be introduced to prevent shoot-through (caused by switches S1 and S2 being turned on at the same time). Signal 24 is provided to the control terminal of switch S2 to control switch S2. Control based on M may be disabled by setting M equal to one. However, the circuit of FIG. 2D is provided merely by way of illustration, as it should be appreciated that the control signals for the switches S1 and S2 may be controlled digitally without the use of an AND gate or other logic. In some embodiments, the control signals may be generated by controller 15.

Some power converters may be controlled by switching frequency modulation. One example of such a converter is an LLC converter. In an LLC converter operated on the inductive side of its transfer function, increasing the switching frequency decreases the output voltage, and decreasing the switching frequency increases the output voltage. In some embodiments, switching frequency modulation may be used in combination with sub-modulation.

Having described how a power cell can be controlled by one or more control parameters, such as duty ratio D, sub-modulation duty ratio M and/or frequency modulation, exemplary control techniques and circuits for controlling stacked power cells will be described.

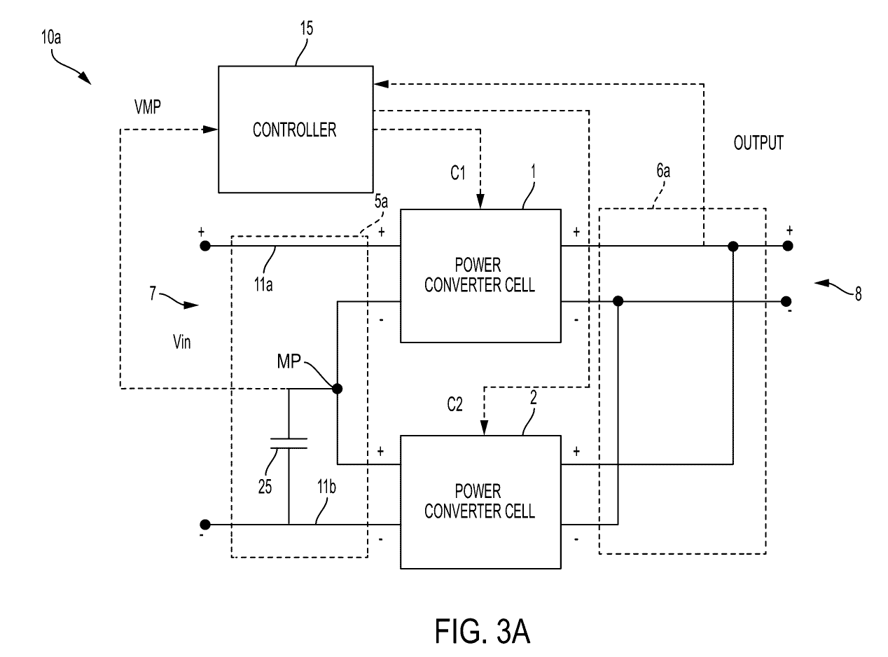

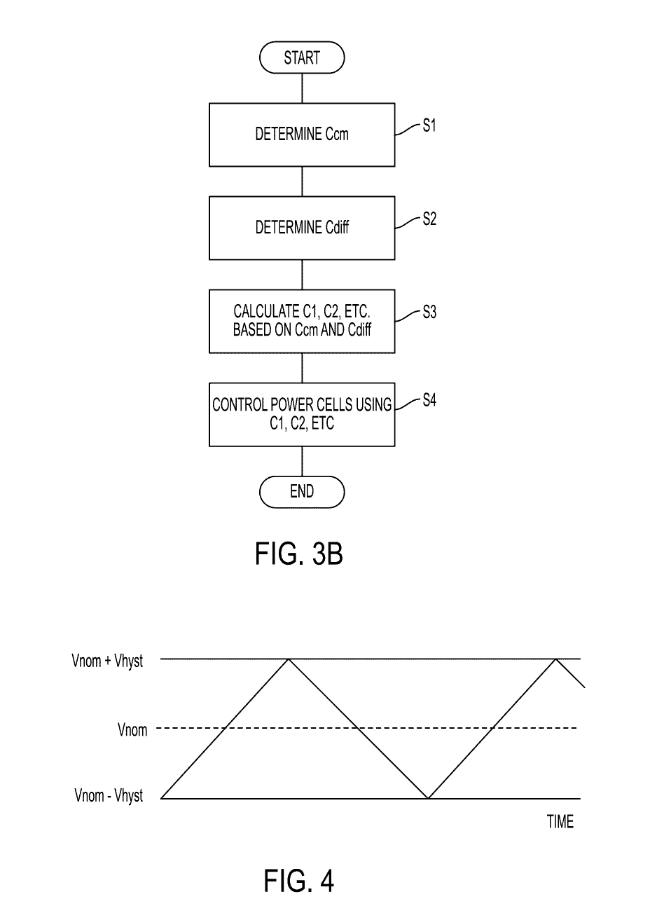

FIG. 3A shows a power converter 10a having two stacked cells 1, 2 with their inputs connected in series by input connection 5a and their outputs connected in parallel by output connection 6a, according to some embodiments. As shown in FIG. 3A, the series-connected inputs of the stacked cells have a midpoint MP. The voltage at the midpoint MP nominally is ½ of the input voltage to the converter (Vin/2), assuming the cells 1 and 2 are substantially the same as one another.

In some embodiments, one or more energy storage devices, such as capacitor(s), for example, may be connected at the midpoint(s). Providing energy storage device(s) at the midpoint(s) may facilitate stabilizing the voltage at the interconnection nodes. In power converter 10a, capacitor 25 has one terminal connected to the midpoint MP and another terminal connected to the low side input 11b of the power cell 2. However, this merely by way of illustration, as in some embodiments a capacitor may have a terminal connected to the high side input 11a of the power cell 1 and another terminal connected to the midpoint MP. In some embodiments, both such capacitors may be included.

As mentioned above, the voltage of the midpoint MP may drift over time, due to differences in components and/or operating points of the stacked power cells, or for other reasons. In some cases, the voltage at the midpoint MP can be unstable. For example, a rise in the voltage of the midpoint MP from its nominal value may cause the currents through the cells 1 and 2 to change in a way that reinforces the rise in voltage, potentially leading to a runaway of the voltage of the midpoint due to positive feedback.

In some embodiments, and as mentioned above, control of a stacked cell power converter may be performed based on a common mode control parameter and a differential mode control parameter, where the output of the power converter is controlled using the common mode control parameter and the midpoint voltage is controlled using the differential mode control parameter. Accordingly, control of the midpoint voltage and the output of the power converter can be decoupled from one another.

As shown in FIG. 3A, the controller 15 may measure the midpoint voltage VMP and the output (voltage, current or power) of the power converter, calculate values of the common mode control parameter and the differential mode control parameter, and control the power cells by setting the control parameters C₁ and C₂ for power cells 1 and 2, respectively, based on the common mode and differential mode control parameters.

Common mode control and differential mode control may be performed by modulating the control parameters. Examples will be described in which the modulation is performed with and without hysteresis. Table 1 lists several permutations of how the common mode control and differential mode control may be performed with and without hysteresis.

TABLE 1
Common and Differential Mode Control Techniques

| | Common Mode | Differential Mode |
|---|---|---|
| | Control | Control |
| 1) | Modulation | Modulation |
| 2) | Modulation | Modulation with |
| | | Hysteresis |
| 3) | Modulation with | Modulation |
| | Hysteresis | |
| 4) | Modulation with | Modulation with |
| | Hysteresis | Hysteresis |

In case 1) shown in the table, control parameters for the two power cells may be represented by the following equations:

C₁=C_{cm}+C_{diff}

C₂=C_{cm}−C_{diff}.

The variable C represents any suitable control parameter of the power converter, including control parameters such as duty ratio D, sub-modulation duty ratio M, switching frequency, or any other suitable control parameter. The parameter C_{cm} is the common mode control parameter, which may control the output of the power converter. The parameter C_{diff} is a differential mode control parameter that controls the midpoint voltage. C_{diff} may be set positive or negative, depending on the direction the midpoint voltage is to be changed.

The voltage of the midpoint is changed in response to the difference in the current through the low-side input terminal 11b of cell 1 and current through the high-side input terminal 11a of cell 2, as the difference between these two currents flows through the capacitor 25 due to Kirchhoff's current law. The voltage across the capacitor and current through the capacitor are related by the equation i_{C}=C·dV/dt. The current through the low-side input terminal of cell 1 and high-side input terminal of cell 2 are adjusted by changing the differential mode control parameter C_{diff}.

If duty ratio D is used as a control parameter for the cells, the duty ratio may be controlled in the common mode and differential mode as represented by the following equations:

D₁=D_{cm}+D_{diff}

D₂=D_{cm}−D_{diff}.

If sub-modulation duty ratio M is used as a control parameter for the cells, the sub-modulation duty ratio may be controlled in the common mode and differential mode as represented by the following equations:

M₁=M_{cm}+M_{diff}

M₂=M_{cm}−M_{diff}.

If switching frequency modulation is used as a control parameter for the cells, the switching frequency may be controlled in the common mode and differential mode as represented by the following equations.

f₁=f_{cm}+f_{diff}

f₂=f_{cm}−f_{diff}.

As can be seen, the control parameter C may be any of D, M or f, or any other suitable control parameter.

In case 2) shown in the table, the common mode control parameter is controlled by modulation, and the differential mode control parameter is controlled by modulation with hysteresis. Control parameters C1 and C2 are represented by the following equations:

C₁=C_{cm}+K

C₂=C_{cm}−K,

which in the case of duty ratio D is,

D₁=D_{cm}+K

D₂=D_{cm}−K,

where the differential mode control parameter is a constant K. As illustrated in FIG. 4, an allowable voltage range may be defined for the midpoint. In this example, Vₙₒₘ represents the nominal midpoint voltage, and V_{hyst} represents the allowable hysteresis band on either side of the nominal midpoint voltage. When the midpoint voltage reaches the upper or lower limit of the hysteresis band, the sign of K is flipped in the above equations, until the midpoint reaches the opposite end of the allowable range, and the sign of K is flipped again, etc. The voltage of the midpoint oscillates back and forth between the boundaries of the hysteresis band. In some embodiments, controlling the midpoint voltage by hysteresis may enable controlling the midpoint with high bandwidth (speed).

The value of K can be any suitable value and can be varied, if desired. A larger value of K causes the midpoint voltage to change more quickly, and a smaller value of K causes the midpoint voltage to change more slowly.

In case 3) shown in the table, the common mode control parameter is controlled by modulation with hysteresis, and the differential mode control parameter is controlled by modulation. Such a control technique may control the output with high bandwidth (speed). The duty ratio may be controlled in the common mode and differential mode as represented by the following equations:

C₁=(K_{A} or K_{B})+C_{diff}

C₂=(K_{A} or K_{B})−C_{diff},

which in the case of duty ratio D is,

D₁=(K_{A} or K_{B})+D_{diff}

D₂=(K_{A} or K_{B})−D_{diff},

where K_{A} and K_{B} are constants that increase and decrease the output of the power converter, respectively. An allowable range may be defined for the output of the power converter, such as an allowable power, voltage or current range. FIG. 4 represents the output voltage in this case, with Vₙₒₘ being the nominal output voltage, and V_{hyst} represents the allowable hysteresis band on either side of the nominal output voltage. Constant K_{A} is used in the above equations to increase the output of the power converter and constant K_{B} is used to decrease the output of the power converter. When a lower limit of the output hysteresis band is reached, K_{A} is used as the common mode control parameter to increase the output until the upper limit of the output hysteresis band is reached, at which point K_{B} is used as the common mode control parameter to decrease the output until the lower limit of the output hysteresis band is reached. The output thus oscillates up and down between the edges of the hysteresis band by changing between K_{A} and K_{B} as the common mode control parameters. K_{A} can have a value of 1 or any other value that causes the output to increase. K_{B} can have a value of zero or any other value (different from K_{A}) that causes the output to decrease.

In case 4) as shown in the table, both the input and the output are controlled by modulation with hysteresis. The duty ratio may be controlled in the common mode and differential mode as represented by the following equations:

C₁=(K_{A} or K_{B})+K_{C}

C₂=(K_{A} or K_{B})−K_{C},

which in the case of duty ratio D is,

D₁=(K_{A} or K_{B})+K_{C}

D₂=(K_{A} or K_{B})−K_{C},

where K_{A}, K_{B} and K_{C} are constants. As discussed above, K_{A} and K_{B} are constants that are used as the common mode control parameter for hysteretic control to increase and decrease, respectively, the output of the power converter within the hysteresis band. K_{C} is used as the differential mode control parameter. As discussed above, the sign of K_{C} in the above equations is flipped when the midpoint voltage reaches the edge of the midpoint hysteresis band.

In some embodiments, different cells may be controlled by different control parameters. Such control parameters can be mapped to one another to produce equal common mode control and equal and opposite differential mode control. As an example for case 1) in the table, one cell may be controlled by a duty ratio control parameter and another cell may be controlled by a sub-modulation control parameter. as represented by the following equations.

D₁=D_{cm}+D_{diff}

M₂=M_{cm}−M_{diff}.

In this example, M_{cm} and D_{cm} produce the same response in the two cells. D_{diff} and M_{diff} produce the opposite response with the same magnitude in the two cells.

As another example, one cell may be controlled by frequency modulation and another cell may be controlled by sub-modulation, as represented by the following equations.

f₁=f_{cm}+f_{diff}

M₂=M_{cm}−M_{diff}.

In some embodiments, different control parameters may be used for the common mode control parameter and the differential mode control parameter. As one example, the common mode control parameter may be duty ratio D, and the differential mode control parameter may be sub-modulation duty ratio M. Output of the power converter may be controlled by the duty ratio D, which is applied to both cells. The midpoint voltage may be changed by changing the sub-modulation duty ratio of the cells in an equal and opposite way. For example, the sub-modulation duty ratio of one cell may be increased by ΔM and while the sub-modulation duty ratio of the other cell is decreased by ΔM. As another example, the common mode control parameter may be frequency and the differential mode control parameter may be sub-modulation duty ratio.

FIG. 3B shows a flowchart of a method of controlling a power converter having a plurality of stacked power cells, according to some embodiments. The method of FIG. 3B may be performed by controller 15, in some embodiments. In step S1, the common mode control parameter C_{cm} is determined. As discussed above, the common mode control parameter C_{cm} may be determined by any suitable control technique, such as feedback or feedforward control. Determining C_{cm} may be performed based upon a desired output of the power converter. In step S2, the differential mode control parameter C_{diff} is determined. As discussed above, the differential mode control parameter C_{diff} may be determined to control a midpoint of the power converter. Any suitable control technique may be used to determine C_{diff}, such as feedback control based on the midpoint voltage, for example. Steps S1 and S2 may be performed in any order, or may be performed simultaneously. In step S3, the control parameters C₁, C₂, etc. of the cells are calculated based upon C_{cm} and C_{diff}. In step S4, the power cells 1, 2, etc. are controlled using the control parameters C₁, C₂, etc. The method may be repeated continuously to control the power converter in real time.

Another technique for controlling the midpoint voltage is to use a type of hysteresis control that reduces the power processed through a cell when the edge of the hysteresis band is reached. The edge(s) of the hysteresis band may be used as threshold(s) for “throttling” the power through a cell for the purpose of changing the midpoint voltage. The power through a cell may be reduced by decreasing a control parameter of the power cell or turning off the power cell. For example, if the midpoint voltage drifts up to the upper edge of the hysteresis band, cell 1 may be turned off for a period of time. Cell 1 may be turned off until the midpoint voltage drifts back into the hysteresis band, or a selected distance into the hysteresis band, and then cell 1 is turned on. Similarly, if the midpoint voltage drifts down to the lower edge of the hysteresis band, cell 2 may be turned off for a period of time. Cell 2 may be turned off until midpoint voltage drifts back into the hysteresis band, or a selected distance into the hysteresis band, and then cell 2 is turned on. As another example, if the edge of the hysteresis band is reached, the sub-modulation duty ratio for a cell may be decreased to cause the midpoint voltage to drift back toward the center of the hysteresis band. If the midpoint voltage drifts up to the upper edge of the hysteresis band, the sub-modulation duty ratio of cell 1 may be decreased for a period of time. Similarly, if the midpoint voltage drifts down to the lower edge of the hysteresis band, the sub-modulation duty ratio of cell 2 may be decreased for a period of time.

Another technique for controlling the midpoint voltage is to use a type of hysteresis control that turns on either the upper cell or the lower cell (i.e., only one of the two cells is on at a time), and switches back and forth between them. Cell 1 may be turned on until the upper edge of the midpoint hysteresis band is reached, and then the upper cell is turned off and cell 2 may be turned on until the lower edge of the midpoint hysteresis band is reached, at which point cell 1 is turned on and cell 2 is turned off, etc. However, if only one cell is turned on at a time, the cells may need to be designed to handle the full output power of the power converter individually.

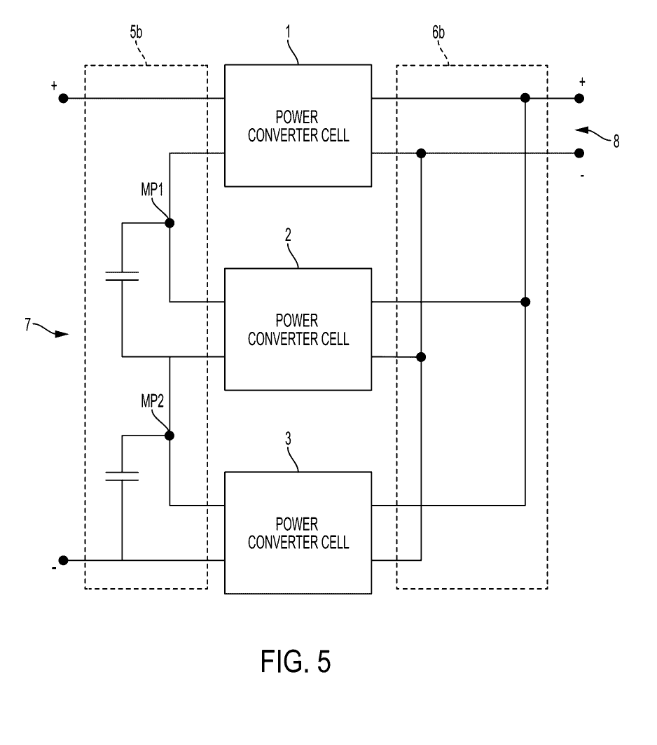

FIG. 5 shows an example of a power converter with three stacked cells having their inputs connected in series and their outputs connected in parallel. In this example there are two midpoints between the inputs of the three cells, MP1 and MP2, nominally at ⅔ and ⅓ of the input voltage of the converter, respectively. As with the case of two stacked cells, the three cells of FIG. 5 may be controlled in the common mode with a common mode control parameter C_{cm}. Differential control parameters may be used to control each of the midpoint voltages, according to the following equations:

C₁=C_{cm}+2C_{diff12}+C_{diff23}

C₂=C_{cm}−C_{diff12}+C_{diff23}

C₃=C_{cm}−C_{diff12}−2C_{diff23}.

As with the example discussed above, the output of the power converter as a whole can be changed by changing the common mode control parameter C_{cm}. The voltage of the first midpoint MP1 can be changed by adding a non-zero differential control parameter Cdiff₁₂. The voltage of the second midpoint MP2 can be changed by adding a non-zero differential control parameter Cdiff₂₃. As discussed above with respect to FIG. 3A, in some embodiments the control of the midpoints and the output may be according duty ratio, hysteresis or both.

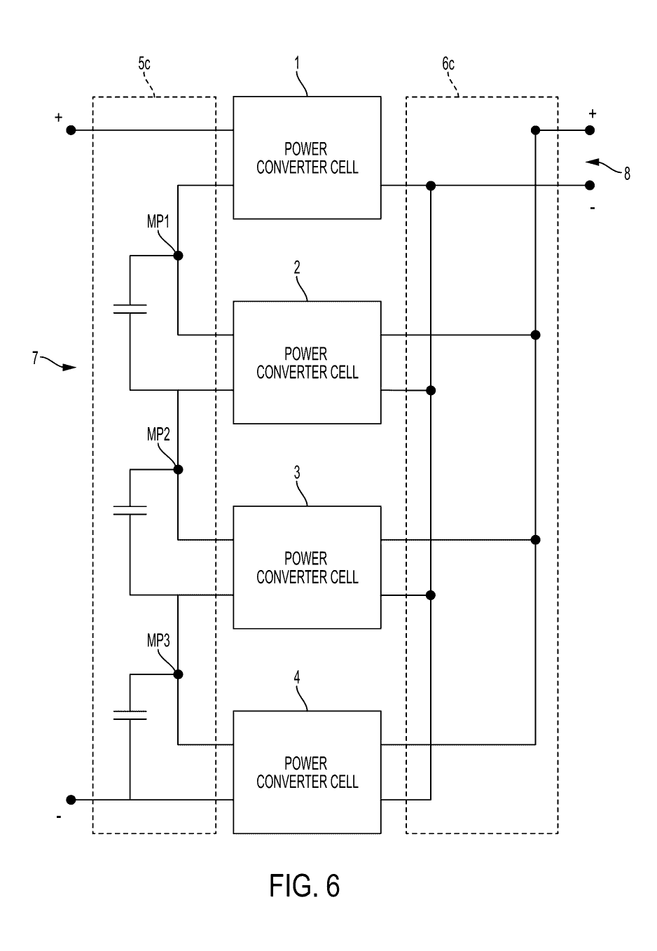

FIG. 6 shows an example of a power converter with four stacked cells having their inputs connected in series and their outputs connected in parallel. There are a variety of ways of controlling four stacked cells in the differential mode and the common mode. One example is to control them using the following equations, where C_{diff12} controls the voltage of midpoint M1, C_{diff23} controls the voltage of midpoint M2, C_{diff34} controls the voltage midpoint M3, and C_{cm} controls the output of the power converter:

C₁=C_{cm}+3C_{diff12}+C_{diff23}+C_{diff34}

C₂=C_{cm}−C_{diff12}+C_{diff23}+C_{diff34}

C₃=C_{cm}−C_{diff12}−C_{diff23}+C_{diff34}

C₄=C_{cm}−C_{diff12}−C_{diff23}−3C_{diff34}.

It should be appreciated that any number of cells may be stacked, and any number of midpoints may be controlled, according to the techniques described herein.

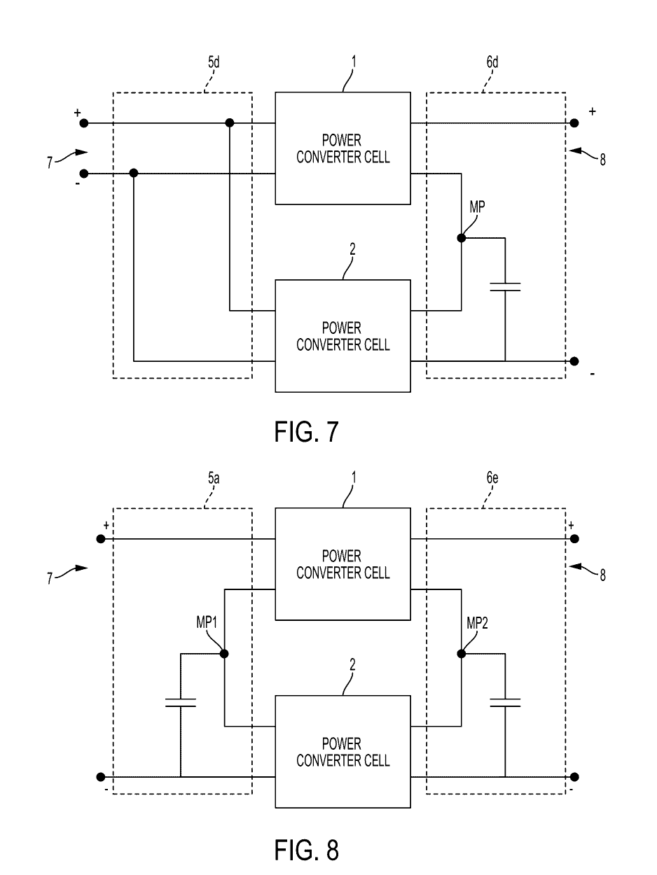

FIG. 7 shows an example of a power converter with two stacked cells having their inputs connected in parallel and their outputs connected in series. As shown in FIG. 7, the outputs have a connection point, or midpoint, MP. The voltage of the midpoint MP may be controlled similarly to the case shown in FIG. 3A, but with the midpoint being on the output instead of the input. Further, there may be more than two stacked cells with a plurality of midpoints on the output, which may be controlled similarly to the cases shown in FIG. 5 and FIG. 6, but with the midpoint being on the output instead of the input.

FIG. 8 shows an example with two stacked cells having their inputs connected in series and their outputs connected in series, with a midpoint MP1 on the input and a midpoint MP2 on the output. Control of the midpoints MP1 and MP2 may be performed similarly to the case shown in FIG. 3A. In some embodiments, either MP1 or MP2 or an arithmetic combination thereof (e.g., their average) may be controlled by modulation of the differential mode control parameter or modulation with hysteresis.

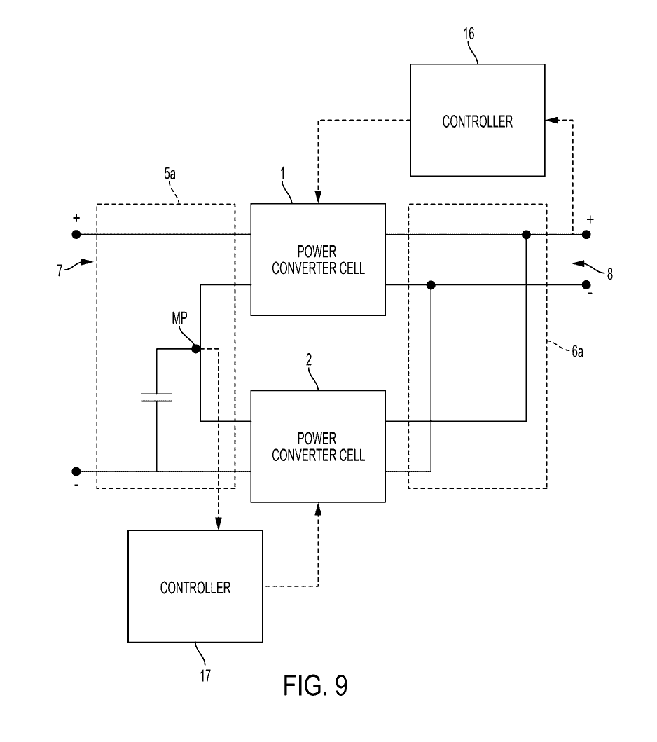

FIG. 9 shows another control technique for controlling the output of the power converter and the midpoint voltage, according to some embodiments. As shown in FIG. 9, cell 1 is controlled to regulate the output voltage of the converter and cell 2 is controlled to regulate the midpoint voltage. Cell 1 may be controlled by controller 16 and cell 2 may be controlled by controller 17. In some embodiments, controller 16 and controller 17 may be implemented by the same controller, as the techniques described herein are not limited using separate controllers. Responsibility for control of the output and the midpoint may be switched in some embodiments, such that cell 1 controls the midpoint voltage and cell 2 controls the output.

The inventors have recognized and appreciated that control of the output voltage and control of the midpoint voltage as shown in FIG. 9 may compete with one another, which can reduce the bandwidth (speed) of the control loop(s). Accordingly, in some embodiments the bandwidths (speeds) of the control loops shown in FIG. 9 may be designed to be different from one another. The bandwidth of controller 16 may be greater than or less than the bandwidth of controller 17, which can reduce the interaction between the control loops. In some embodiments, the bandwidth (speed) of controller 16 may be 10× or more greater than, or 10× or more less than, the bandwidth (speed) of controller 17, to reduce the interaction between the control loops.

Gain Scheduling

The inventors have recognized and appreciated that a power converter can have a gain that varies with the input and/or output of the power converter (e.g., input or output voltage, input or output current, or input or output power). For example, in the case of a phi-2 converter, the gain may be low for low input voltages and higher for higher input voltages. Although the output of the power converter can be controlled by various control techniques, the gain dependency of the power converter on the input and/or output of the power converter can affect various aspects of the control. For example, at a low input voltage a phi-2 converter may have a low gain, a low bandwidth and a high phase margin. For a higher input voltage, the phi-2 converter may have a high gain, a high bandwidth and a low phase margin. The variation can be particularly pronounced in an AC/DC converter with a widely varying voltage at the input. It can be desirable to mitigate the change in parameters of the power converter caused by changes in its input and/or output. For example, it may be advantageous to make the converter more stable across its operating range. Such techniques may be particularly useful where a power converter, such as a phi-2 converter, is operated across a wide range of input and/or output voltages.

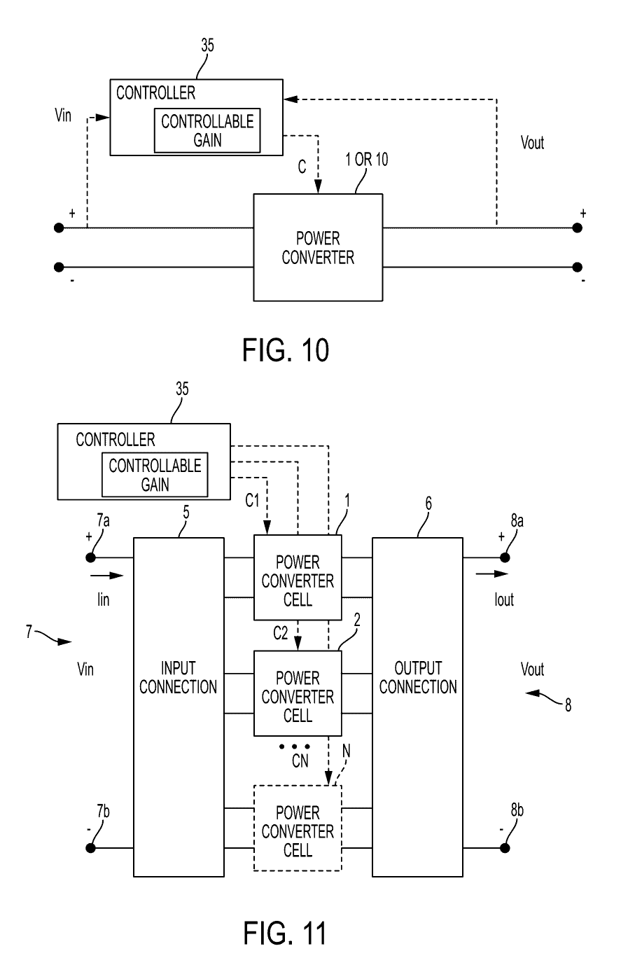

In some embodiments, the gain of a controller that controls a power converter may be changed based on the input (e.g., voltage) of the power converter, the output (e.g., voltage) of the power converter, or both the input and the output of the power converter. FIG. 10 illustrates a controller 35 that controls a power converter using a controllable gain. The controller may store a suitable gain schedule that identifies a gain for the controller based on the measured input voltage and/or output voltage of the power converter. A suitable set of gain values for input and/or output voltage may be selected based on the type of converter and the properties that are desired to be achieved. For example, in a phi-2 converter, a relatively high gain for the controller may be selected for low input voltages, and lower gain may be selected for higher input voltages, to counter the natural tendency of the phi-2 converter to have a low gain at low input voltage and a higher gain at higher voltages.

The controller gain may be set such that any number of one or more parameters stay within a desired operating range. Examples of such parameters include control loop bandwidth, phase margin, rise time and overshoot. Setting the controller gain based on input and/or output voltage can make the bandwidth of the controller more uniform across the input and/or output voltage range, and can make the converter more stable by making the phase margin more uniform across the input and/or output voltage range.

The gain scheduling may be implemented with hysteresis to avoid noise in the system causing a change in the gain of the controller. For example, increasing the gain from value A to value B may be performed at different input and/or output voltages than decreasing the gain from value B to value A. The gain may not be increased from value A to value B until the input and/or output voltages are a sufficient distance into an operating range where value B may be desired, to prevent noise from causing a change from value A to value B. Similarly, decreasing the gain from value B to value A may not be performed until the input and/or output voltages are a sufficient distance into an operating range where value A may be desired.

The controller shown in FIG. 10 may be implemented using any suitable control technique. In some embodiments the controller may be implemented using a PI controller having a proportional gain and an integral gain. The gain schedule may include either or both of the proportional gain and the integral gain, and allow the controller to vary either the proportional gain, the integral gain, or both, for variations in the input and/or output of the power converter. However, a PI controller is described merely by way of example, and it should be appreciated that any suitable controller or control technique may be used.

FIG. 11 shows a controller 35 that controls a plurality of stacked cells of a power converter. The controller may set the same gain for each of the cells, based on a gain schedule, or may set individual gains for individual cells. The controller can adjust the gain based on the input voltage of the power converter, the input voltage of a cell, the output voltage of a cell, the output voltage of the converter, the current and/or power through any of the above, or any combination of such parameters. The controller may be a single controller to control all of the cells, as shown in FIG. 11, or may be a plurality of controllers to control individual cells.

In some embodiments, gain scheduling can allow reducing the input capacitance at the input of a cell. For example, rather than using an input capacitor of several microfarads, the input capacitance may be reduced to several hundred nanofarads, in some embodiments.

Described above are power converters and control techniques. Such power converters may be used in power adapters which may be used for powering and/or charging consumer electronic devices. However, the techniques described herein are not limited to power adapters for consumer electronic devices. Some embodiments relate to a power conversion module for other electronic devices, such as servers or other devices in a data center, which may benefit from a reduction in size of the power electronics. Other non-limiting examples of applications include power electronics for industrial equipment and electronics for automobiles, aircraft and ships.

Controller(s) and Computing Devices

The controllers described herein may be implemented by circuitry such as electronic circuits or a programmed processor (i.e., a computing device), such as a microprocessor, or any combination thereof.

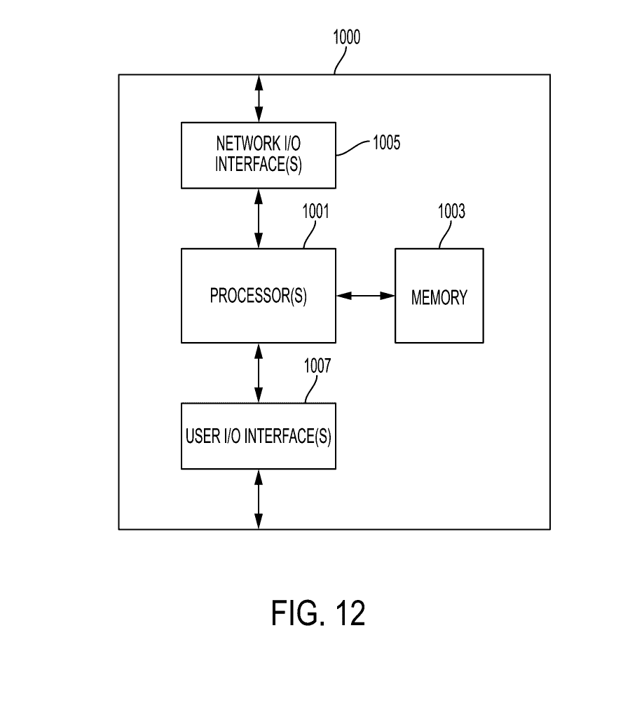

FIG. 12 is a block diagram of an illustrative computing device 1000 that may be used to implement any of the above-described techniques. Computing device 1000 may include one or more processors 1001 and one or more tangible, non-transitory computer-readable storage media (e.g., memory 1003). Memory 1003 may store, in a tangible non-transitory computer-recordable medium, computer program instructions that, when executed, implement any of the above-described functionality. Processor(s) 1001 may be coupled to memory 1003 and may execute such computer program instructions to cause the functionality to be realized and performed.

Computing device 1000 may also include a network input/output (I/O) interface 1005 via which the computing device may communicate with other computing devices (e.g., over a network), and may also include one or more user I/O interfaces 1007, via which the computing device may provide output to and receive input from a user. The user I/O interfaces may include devices such as a keyboard, a mouse, a microphone, a display device (e.g., a monitor or touch screen), speakers, a camera, and/or various other types of I/O devices.

The above-described embodiments can be implemented in any of numerous ways. For example, the embodiments may be implemented using hardware, software or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-discussed functions of one or more embodiments. The computer-readable medium may be transportable such that the program stored thereon can be loaded onto any computing device to implement aspects of the techniques discussed herein. In addition, it should be appreciated that the reference to a computer program which, when executed, performs any of the above-discussed functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques discussed herein.

Various aspects of the apparatus and techniques described herein may be used alone, in combination, or in a variety of arrangements not specifically discussed in the embodiments described in the foregoing description and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A power converter, comprising:
a plurality of stacked power cells; and
a controller configured to control the plurality of stacked power cells using a common mode control parameter that controls respective power cells of the plurality of stacked power cells in a same way and a differential mode control parameter that controls respective power cells of the plurality of stacked power cells in an opposing way to change a voltage of a connection terminal between at least two of the plurality of stacked power cells.

2. The power converter of claim 1, wherein the common mode control parameter controls an output of the power converter.

3. The power converter of claim 2, wherein the common mode control parameter does not affect a voltage of the connection terminal.

4. The power converter of claim 1, wherein the differential mode control parameter does not affect an output of the power converter.

5. The power converter of claim 1, wherein the controller is configured to calculate a first control parameter for a first power cell of the plurality of stacked power cells based on the common mode control parameter and the differential mode control parameter.

6. The power converter of claim 5, wherein the first control parameter is calculated as a sum or difference of the common mode control parameter and the differential mode control parameter.

7. The power converter of claim 6, wherein the controller is configured to calculate a second control parameter of a second power cell of the plurality of stacked power cells as a sum or difference of the common mode control parameter and the differential mode control parameter.

8. The power converter of claim 6, wherein the first control parameter is calculated using hysteresis.

9. The power converter of claim 1, further comprising a capacitor coupled to the connection terminal.

10. A method of controlling a power converter having a plurality of stacked power cells, the method comprising:
controlling the plurality of stacked power cells using a common mode control parameter that controls respective power cells of the plurality of stacked power cells in a same way and a differential mode control parameter that controls respective power cells of the plurality of stacked power cells in an opposing way to change a voltage of a connection terminal between at least two of the plurality of stacked power cells.

11. At least one computer readable storage medium having stored thereon instructions, which, when executed by a processor, perform a method of controlling a power converter, the method comprising:
controlling the plurality of stacked power cells using a common mode control parameter that controls respective power cells of the plurality of stacked power cells in a same way and a differential mode control parameter that controls respective power cells of the plurality of stacked power cells in an opposing way to change a voltage of a connection terminal between at least two of the plurality of stacked power cells.

12. A controller for a power converter having a plurality of stacked power cells, the controller comprising:
circuitry configured to control the plurality of stacked power cells using a common mode control parameter that controls respective power cells of the plurality of stacked power cells in a same way and a differential mode control parameter that controls respective power cells of the plurality of stacked power cells in an opposing way to change a voltage of a connection terminal between at least two of the plurality of stacked power cells.

13. A power converter, comprising:
a plurality of stacked power cells; and
a controller configured to control a voltage of a connection terminal between the plurality of stacked power cells at least in part by modifying a first control parameter of at least one first power cell of the plurality of stacked power cells to produce a change in output of the at least one first power cell, and modifying a second control parameter of at least one second power cell of the plurality of stacked power cells to produce a change in output of the at least one second power cell that is opposite to the change in output of the at least one first power cell.

14. The power converter of claim 13, wherein,
the modifying of the first control parameter increases an output power of the at least one first power cell and decreases an output power of the at least one second power cell, or
the modifying of the first control parameter decreases an output power of the at least one second power cell and increases an output power of the at least one second power cell.

15. The power converter of claim 14, wherein the modifying of the first and second control parameters does not affect an output power of the power converter.

16. The power converter of claim 13, wherein the first control parameter comprises at least one of duty ratio, sub-modulation duty ratio and switching frequency and the second control parameter comprises at least one of duty ratio, sub-modulation duty ratio and switching frequency.

17. The power converter of claim 16, wherein the first control parameter comprises duty ratio or sub-modulation duty ratio, the second control parameter comprises duty ratio or sub-modulation duty ratio, the first control parameter is modified by a first magnitude and a first sign, and the second control parameter is modified by the first magnitude a second sign opposite to the first sign.

18. A method of controlling a power converter having a plurality of stacked power cells, the method comprising:
controlling a voltage of a connection terminal between the plurality of stacked power cells at least in part by:
modifying a first control parameter of at least one first power cell of the plurality of stacked power cells to produce a change in output of the at least one first power cell; and
modifying a second control parameter of at least one second power cell of the plurality of stacked power cells to produce a change in output of the at least one second power cell that is opposite to the change in output of the at least one first power cell.

19. At least one computer readable storage medium having stored thereon instructions, which, when executed by a processor, perform a method of controlling a power converter, the method comprising:
controlling a voltage of a connection terminal between the plurality of stacked power cells at least in part by:
modifying a first control parameter of at least one first power cell of the plurality of stacked power cells to produce a change in output of the at least one first power cell; and
modifying a second control parameter of at least one second power cell of the plurality of stacked power cells to produce a change in output of the at least one second power cell that is opposite to the change in output of the at least one first power cell.

20. A controller for a power converter having a plurality of stacked power cells, the controller comprising:
circuitry configured to control a voltage of a connection terminal between the plurality of stacked power cells at least in part by modifying a first control parameter of at least one first power cell of the plurality of stacked power cells to produce a change in output of the at least one first power cell, and modifying a second control parameter of at least one second power cell of the plurality of stacked power cells to produce a change in output of the at least one second power cell that is opposite to the change in output of the at least one first power cell.
